(19) United States
(12) Patent Application Publication
(10) Pub. No.: US 2020/0061624 A1
(43) Pub. Date: Feb. 27, 2020

(54) Pulverizing and Packaging Device for Crushing Glass

(71) Applicant: Liping Ye, Fuzhou city (CN)

(72) Inventor: Liping Ye, Fuzhou city (CN)

(21) Appl. No.: 16/671,195

(22) Filed: Nov. 1, 2019

(30) Foreign Application Priority Data
Jul. 15, 2019 (CN) 2019106370611

(51) Int. Cl. B02C 1/00

(52) U.S. Cl. CPC B02C 1/00; B02C 19/0087; B02C 2201/06

(57) ABSTRACT

The invention discloses a pulverizing and packaging device for crushing glass, comprising a casing, wherein the casing is provided with an opening chamber with an opening upward, and the working chamber is provided with a collecting mechanism, and the collecting mechanism can collect common garbage. The working chamber is further provided with a pulverizing mechanism capable of pulverizing the crushed glass, and the lower side of the pulverizing mechanism is provided with a packing mechanism, and the working chamber is further provided There is a closing mechanism, The device is simple to operate, after the broken glass is thrown in, the glass is temporarily stored, and the cover is covered. After the glass is crushed into the garbage bag, the device can automatically pack the garbage bag, avoiding the contact between the person and the glass, and reducing the glass. The possibility of scratching.

### CROSS-REFERENCES TO RELATED APPLICATIONS

The present application claims priority from Chinese application No. 2019106370611 filed on Jul. 15, 2019 which is hereby incorporated by reference in its entirety.

### TECHNICAL FIELD

The invention relates to the field of mechanism, in particular to a pulverizing and packaging device for crushing glass.

### BACKGROUND OF THE INVENTION

Many people choose to throw the broken glass directly into the trash after the glass is broken. When the sanitation worker cleans the trash can, he will be injured by the broken glass when he is not paying attention. There is a serious safety hazard, and he chooses himself. When packing broken glass pieces, it is very likely that you will injure yourself because of negligence or improper handling, and directly place the glass fragments in a conspicuous place outside the trash can, posing a safety hazard to children playing on the road.

### BRIEF SUMMARY OF THE INVENTION

The technical problem to be solved by the invention is to provide a pulverizing and packaging device for crushing glass, so as to overcome the problems existing in the prior art.

A pulverizing and packaging device for crushing glass comprises a casing 29, wherein the casing 29 is provided with a working chamber 39 having an opening upward, and the working chamber 39 is provided The collecting mechanism 81 is capable of collecting common garbage, and the upper side of the outer casing 29 is provided with a rotatable cover plate 12, and the cover plate 12 can cover the working cavity 39 to prevent the garbage from running out;

The working chamber 39 is further provided with a pulverizing mechanism 82. The pulverizing mechanism 82 includes a narrow groove 75 disposed on the rear end wall of the working chamber 39. The left and right end walls of the narrow groove 75 are symmetrically provided with a magnet strip. 74. The narrow slot 75 is provided with a slider 76 that can slide up and down. The front end surface of the slider 76 is fixedly provided with a slash 73. The lower end surface of the slash 73 is fixedly provided with a battery 72. The working cavity 39 A small block 49 is fixedly disposed on the rear end wall. The front end surface of the small block 49 is fixedly provided with a motor 44 and a socket 47. The right end surface of the motor 44 is rotated to provide a first crushing shaft 45, and the first crushing shaft 45 is rearward. a second crushing shaft 92 is disposed on the side, and the first crushing shaft 45 and the second crushing shaft 92 can crush the crushed glass;

The lower side of the pulverizing mechanism 82 is provided with a packing mechanism 84. The packing mechanism 84 includes a short plate 33 fixed on the rear end wall of the working chamber 39. The upper side of the short plate 33 is provided with a load frame 41. A garbage bag 43 is disposed in the load frame 41, and the garbage bag 43 can store the smashed glass fragments;

The working chamber 39 is further provided with a closing mechanism 83. The closing mechanism 83 includes a thin rod 15 fixed on the rear end wall of the working chamber 39. The thin rod 15 is rotated and provided with a baffle 16, The baffle 16 can block the glass shards when the cover 12 is opened to prevent the shards of glass from falling.

Further, the collecting mechanism 81 is described in detail. The collecting mechanism 81 further includes an input housing 18 fixed to the rear end wall of the working chamber 39. The input housing 18 is provided with an opening chamber with an opening upward. A first round rod 13 is fixedly disposed on a rear end wall of the working chamber 39. The first round rod 13 is rotated and provided with a long rod 28, and the right end of the long rod 28 is fixedly connected with a horizontal block 27, The lower end of the right end wall of the working chamber 39 has a short cavity 26 with an opening facing outward. The horizontal block 27 extends out of the outer casing 29 through the short cavity 26, and the vertical end of the upper end of the long rod 28 is provided with a vertical rod 14 A vertical slot 59 is defined in the rear end wall of the working chamber 39. The vertical rod 14 can move up and down in the vertical slot 59. The upper side of the vertical rod 14 is provided with a cover plate 12, A long shaft 11 is disposed on the left side of the cover plate 12, and a curved rod 10 is symmetrically fixed to the left end surface of the outer casing 29. The curved rod 10 is rotatably connected to the long shaft 11.

Further, the pulverizing mechanism 82 is described in detail. The pulverizing mechanism 82 further includes a vertical slot 40 located in the rear end wall of the working chamber 39. The vertical slot 40 is vertically slidably disposed with a vertical rod 38. The lower side of the vertical rod 38 is provided with a movable plate 35. The movable plate 35 is rotatably connected to the second round rod 36. The second round rod 36 is fixed on the rear end wall of the working chamber 39, and the second A torsion spring 37 is disposed between the round rod 36 and the movable plate 35. The socket 47 is connected to the motor 44 by the electric wire 46. The first crushing shaft 45 is fixedly provided with a first gear 90. A second gear 91 is fixedly disposed on the second crushing shaft 92. The first gear 90 meshes with the second gear 91. The first gear 90 can drive the second gear 91 to rotate.

The packing mechanism 84 is further described in detail. The packing mechanism 84 further includes a packing frame 31 fixed on the rear end wall of the working chamber 39. The lower side of the packing frame 31 is provided with a load frame 41. A return spring 34 is disposed between the load frame 41 and the short plate 33. The load frame 41 is provided with a load carrying chamber 42. A telescopic spring 32 is fixedly disposed on the right side of the upper end surface of the short plate 33. The upper side of the 32 is provided with a transmission rod 23, and a third round rod 30 is fixedly disposed on the rear end wall of the working chamber 39. The third round rod 30 is fixedly provided with a transmission gear 24 and a reel from the back to the front. The transmission gear 24 is meshed with the transmission rod 23, and the packaging frame 31 is provided with a horizontal groove 54. The lower end wall of the lateral groove 54 is provided with a small groove 60. The small groove 60 is slid back and forth. a limiting block 61, the limiting block 61 is connected to the reel 25 by a thin wire 62, the limiting block 61 can drive the short rod 55 to move back and forth, and the front side of the short rod 55 is fixedly provided with a heating strip 56. A small socket 58 is fixed on the upper side of the heating bar 56. The small socket 58 can move back and forth with the short rod 55. The small socket 58 and the heating bar 56 A small electric wire 67 is disposed between the front end wall of the packaging frame 31, and a small heating battery 70 is fixed in the heating chamber 70. The front end wall of the packaging frame 31 is provided with an opening. The front wide groove 71 is provided with a horizontal shaft 68. The left end of the horizontal shaft 68 is fixedly provided with a gear 63. The lower side of the horizontal shaft 68 is fixedly connected with a small door 80.

Advantageously, the closure mechanism 83 is described in detail. The closure mechanism 83 includes a fourth round rod 66 fixed to the rear end wall, and the fourth round rod 66 is fixedly provided with a large gear 48. A pinion 50 fixedly connected to the fourth round bar 66 is disposed on a front side of the gear 48. A sliding groove 85 is disposed in a rear end wall of the working cavity 39. The sliding block 85 is vertically slidably provided with a wooden block 52. A rack 53 is fixedly disposed on the left end surface of the block 52, and the rack 53 is engaged with the pinion 50. The first block 88 and the second riser 87 are sequentially disposed on the right side of the block 52. The three vertical plates 22 and the fourth vertical plate 20 are fixed on the left end surface of the fourth vertical plate 20 with an inclined downward inclined plate 21.

Advantageously, the slider 76 can remain stationary when not subjected to an external force, and does not come into contact with the vertical rod 38 when moving downward. When the vertical rod 38 moves upward, the slider can be moved. 76 reset.

Advantageously, the thin wire 62 projects to the right, and when the baffle 16 is rotated upward, the baffle 16 is still slightly inclined downward to the right.

Beneficially, the upper side of the garbage bag 43 is placed on the upper side of the packing frame 31.

### BRIEF DESCRIPTION OF THE DRAWINGS

FIG. 1 is a schematic view of the overall structure of the present invention;

FIG. 2 is a schematic view showing the structure of A-A in FIG. 1;

FIG. 3 is a right side view of the arcuate block 52 of FIG. 1;

FIG. 4 is a schematic view showing the structure of B-B in FIG. 1;

FIG. 5 is a schematic view showing the structure of C-C in FIG. 1;

FIG. 6 is a schematic view showing the structure of D in FIG. 1;

### DETAILED DESCRIPTION OF THE INVENTION

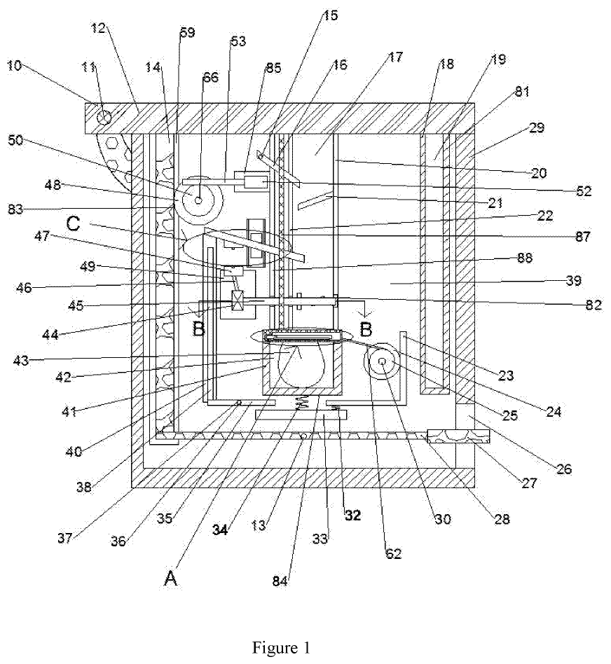

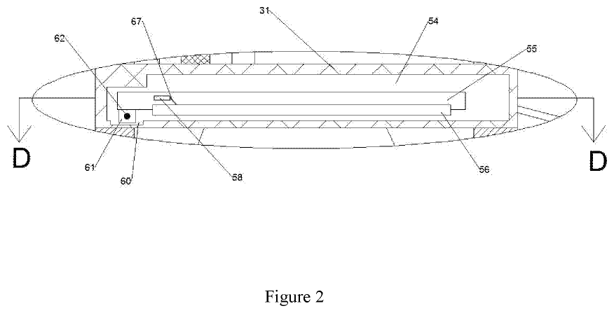

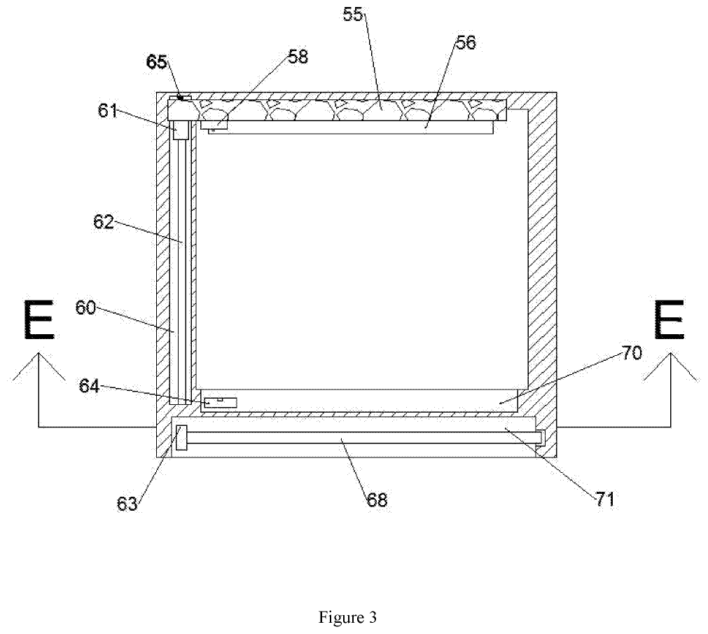

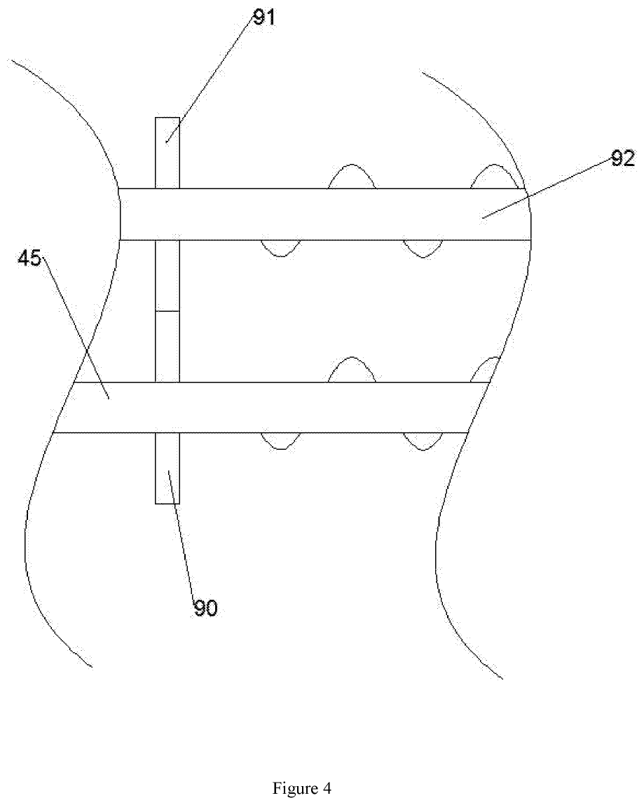

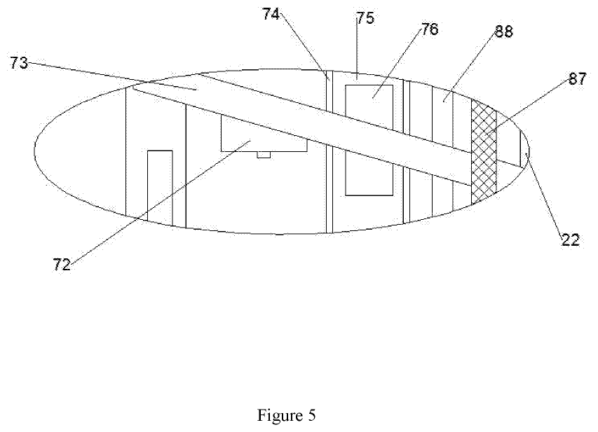

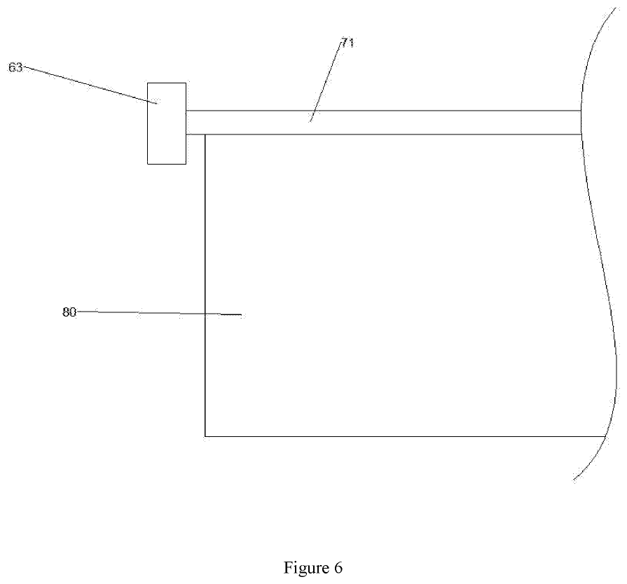

The invention will be described in detail below referring to FIG. 1 to FIG. 6. For better explanation, the orientations described hereinafter are defined as follows: directions of up, down, front and rear in the text are identical to the directions of up, down, front and rear of FIG. 1.

A schematic diagram of a mechanical mechanism for a pulverizing and packaging device for crushing glass according to the accompanying drawings 1-6, comprising a casing 29, wherein the casing 29 is provided with a working chamber 39 having an opening upward, and the working chamber 39 is provided The collecting mechanism 81 is capable of collecting common garbage, and the upper side of the outer casing 29 is provided with a rotatable cover plate 12, and the cover plate 12 can cover the working cavity 39 to prevent the garbage from running out;

The working chamber 39 is further provided with a pulverizing mechanism 82. The pulverizing mechanism 82 includes a narrow groove 75 disposed on the rear end wall of the working chamber 39. The left and right end walls of the narrow groove 75 are symmetrically provided with a magnet strip. 74. The narrow slot 75 is provided with a slider 76 that can slide up and down. The front end surface of the slider 76 is fixedly provided with a slash 73. The lower end surface of the slash 73 is fixedly provided with a battery 72. The working cavity 39 A small block 49 is fixedly disposed on the rear end wall. The front end surface of the small block 49 is fixedly provided with a motor 44 and a socket 47. The right end surface of the motor 44 is rotated to provide a first crushing shaft 45, and the first crushing shaft 45 is rearward. a second crushing shaft 92 is disposed on the side, and the first crushing shaft 45 and the second crushing shaft 92 can crush the crushed glass;

The lower side of the pulverizing mechanism 82 is provided with a packing mechanism 84. The packing mechanism 84 includes a short plate 33 fixed on the rear end wall of the working chamber 39. The upper side of the short plate 33 is provided with a load frame 41. A garbage bag 43 is disposed in the load frame 41, and the garbage bag 43 can store the smashed glass fragments;

The working chamber 39 is further provided with a closing mechanism 83. The closing mechanism 83 includes a thin rod 15 fixed on the rear end wall of the working chamber 39. The thin rod 15 is rotated and provided with a baffle 16, The baffle 16 can block the glass shards when the cover 12 is opened to prevent the shards of glass from falling.

Further, the collecting mechanism 81 is described in detail. The collecting mechanism 81 further includes an input housing 18 fixed to the rear end wall of the working chamber 39. The input housing 18 is provided with an opening chamber with an opening upward. A first round rod 13 is fixedly disposed on a rear end wall of the working chamber 39. The first round rod 13 is rotated and provided with a long rod 28, and the right end of the long rod 28 is fixedly connected with a horizontal block 27, The lower end of the right end wall of the working chamber 39 has a short cavity 26 with an opening facing outward. The horizontal block 27 extends out of the outer casing 29 through the short cavity 26, and the vertical end of the upper end of the long rod 28 is provided with a vertical rod 14 A vertical slot 59 is defined in the rear end wall of the working chamber 39. The vertical rod 14 can move up and down in the vertical slot 59. The upper side of the vertical rod 14 is provided with a cover plate 12, A long shaft 11 is disposed on the left side of the cover plate 12, and a curved rod 10 is symmetrically fixed to the left end surface of the outer casing 29. The curved rod 10 is rotatably connected to the long shaft 11.

Further, the pulverizing mechanism 82 is described in detail. The pulverizing mechanism 82 further includes a vertical slot 40 located in the rear end wall of the working chamber 39. The vertical slot 40 is vertically slidably disposed with a vertical rod 38. The lower side of the vertical rod 38 is provided with a movable plate 35. The movable plate 35 is rotatably connected to the second round rod 36. The second round rod 36 is fixed on the rear end wall of the working chamber 39, and the second A torsion spring 37 is disposed between the round rod 36 and the movable plate 35. The socket 47 is connected to the motor 44 by the electric wire 46. The first crushing shaft 45 is fixedly provided with a first gear 90. A second gear 91 is fixedly disposed on the second crushing shaft 92. The first gear 90 meshes with the second gear 91. The first gear 90 can drive the second gear 91 to rotate.

The packing mechanism 84 is further described in detail. The packing mechanism 84 further includes a packing frame 31 fixed on the rear end wall of the working chamber 39. The lower side of the packing frame 31 is provided with a load frame 41. A return spring 34 is disposed between the load frame 41 and the short plate 33. The load frame 41 is provided with a load carrying chamber 42. A telescopic spring 32 is fixedly disposed on the right side of the upper end surface of the short plate 33. The upper side of the 32 is provided with a transmission rod 23, and a third round rod 30 is fixedly disposed on the rear end wall of the working chamber 39. The third round rod 30 is fixedly provided with a transmission gear 24 and a reel from the back to the front. The transmission gear 24 is meshed with the transmission rod 23, and the packaging frame 31 is provided with a horizontal groove 54. The lower end wall of the lateral groove 54 is provided with a small groove 60. The small groove 60 is slid back and forth. a limiting block 61, the limiting block 61 is connected to the reel 25 by a thin wire 62, the limiting block 61 can drive the short rod 55 to move back and forth, and the front side of the short rod 55 is fixedly provided with a heating strip 56. A small socket 58 is fixed on the upper side of the heating bar 56. The small socket 58 can move back and forth with the short rod 55. The small socket 58 and the heating bar 56 A small electric wire 67 is disposed between the front end wall of the packaging frame 31, and a small heating battery 70 is fixed in the heating chamber 70. The front end wall of the packaging frame 31 is provided with an opening. The front wide groove 71 is provided with a horizontal shaft 68. The left end of the horizontal shaft 68 is fixedly provided with a gear 63. The lower side of the horizontal shaft 68 is fixedly connected with a small door 80.

Advantageously, the closure mechanism 83 is described in detail. The closure mechanism 83 includes a fourth round rod 66 fixed to the rear end wall, and the fourth round rod 66 is fixedly provided with a large gear 48. A pinion 50 fixedly connected to the fourth round bar 66 is disposed on a front side of the gear 48. A sliding groove 85 is disposed in a rear end wall of the working cavity 39. The sliding block 85 is vertically slidably provided with a wooden block 52. A rack 53 is fixedly disposed on the left end surface of the block 52, and the rack 53 is engaged with the pinion 50. The first block 88 and the second riser 87 are sequentially disposed on the right side of the block 52. The three vertical plates 22 and the fourth vertical plate 20 are fixed on the left end surface of the fourth vertical plate 20 with an inclined downward inclined plate 21.

Advantageously, the slider 76 can remain stationary when not subjected to an external force, and does not come into contact with the vertical rod 38 when moving downward. When the vertical rod 38 moves upward, the slider can be moved. 76 reset.

Advantageously, the thin wire 62 projects to the right, and when the baffle 16 is rotated upward, the baffle 16 is still slightly inclined downward to the right.

Beneficially, the upper side of the garbage bag 43 is placed on the upper side of the packing frame 31.

The sequence of mechanical actions of the entire device:

(1) Stepping on the horizontal block 27, the long rod 28 rotates clockwise, and drives the vertical long rod 14 to move upward. The cover plate 12 is turned upward by the vertical long rod 14, and the vertical long rod 14 drives the large gear 48 to mesh and transmit, the pinion gear When the large gear 48 rotates together, the wooden block 52 is translated to the right, and the baffle 16 is rotated to throw the broken glass into the crushing chamber 17. The broken glass temporarily stays on the upper end surface of the baffle 16, and ordinary garbage can be thrown into the input cavity. Within 19.

(2) The horizontal block 27 is loosened, the cover plate 12 is reset by gravity, and the vertical long rod 14 is moved downward. The vertical long rod 14 drives the large gear 48 to rotate, and the small gear 50 rotates together with the large gear 48, and the wooden block 52 is turned toward When moving to the left, the baffle 16 is rotated clockwise by gravity, the glass fragments fall along the slope, and the slash 73 is slanted, the slash 73 moves downward, the battery 72 is inserted into the socket 47, the motor 44 starts to work, and the glass shards are A crushing shaft 45 and the second crushing shaft 92 are pulverized and then dropped into the garbage bag 43.

(3) After the glass falls into the garbage bag 43, the load frame 41 is moved downward by gravity, the movable plate 35 is rotated clockwise, the vertical rod 38 is moved upward, the slash 73 is pushed back to the original position, and the motor 44 stops rotating. The transmission rod 23 descends with the load frame 41, and drives the gear transmission gear 24 to rotate. The reel 25 rotates with the transmission gear 24, tightens the thin wire 62, and pulls the short rod 55 forward through the thin wire 62 to drive the garbage bag 43. Moving forward, the small socket 58 is advanced along with the short rod 55, inserted into the small battery 64, and the heating rod 56 is energized to seal the garbage bag 43.

(4) The restricting block 61 moves forward with the short rod 55, drives the gear 63 to rotate, the horizontal shaft 68 rotates together with the gear 63, and the horizontal shaft 68 drives the small door 80 to rotate. At this time, the garbage bag 43 can be taken out from the load carrying chamber 42. After being taken out, the load frame 41 is not subjected to gravity, is reset upward, the transmission rod 23 moves upward together, the transmission rod 23 drives the transmission gear 24 to rotate, the reel 25 rotates with the transmission gear 24, the thin wire 62 relaxes, and the small spring 65 pulls The short rod 55 is reset rearward, the small socket 58 and the small battery 64 are separated from each other, and the heating bar 56 is stopped.

The above embodiments are only intended to illustrate the technical concept and the features of the present invention, and the purpose of the present invention is to enable those skilled in the art to understand the present invention and to implement the present invention. Equivalent variations or modifications made in accordance with the spirit of the invention are intended to be included within the scope of the invention.

1. A pulverizing and packaging device for crushing glass, comprising:
a casing;
the housing is provided with an open working chamber, the working chamber is provided with a collecting mechanism, the collecting mechanism can collect common garbage, and the upper side of the outer casing is provided with a rotatable cover, and the cover can Cover the working chamber to prevent the garbage from running out;
a pulverizing mechanism is further disposed in the working chamber, the pulverizing mechanism includes a narrow groove disposed on a rear end wall of the working cavity, and a magnet bar is symmetrically disposed on the left and right end walls of the narrow groove, and the narrow groove is a sliding block capable of sliding up and down, a front side of the sliding block is fixedly provided with a slash, a lower end surface of the slanting bar is fixedly provided with a battery, and a small block is fixed on a rear end wall of the working cavity, and the small block is fixed The front end surface is fixedly provided with a motor and a socket, the right end surface of the motor is rotated to be provided with a first crushing shaft, and the rear side of the first crushing shaft is provided with a second crushing shaft, the first crushing shaft and the second crushing shaft Can crush the broken glass;
the bottom side of the pulverizing mechanism is provided with a packing mechanism, the packing mechanism comprises a short plate fixed on the rear end wall of the working cavity, the short plate side is provided with a load frame, and the load frame is provided with a garbage bag The garbage bag can store the smashed glass fragments;
The working chamber is further provided with a closing mechanism, the closing mechanism comprises a thin rod fixed on the rear end wall of the working chamber, and the thin rod is rotated and provided with a baffle, and the baffle can be in the cover When the board is open, stop the glass fragments and prevent the glass fragments from falling.

2. The pulverizing and packaging device for crushing glass according to claim 1, wherein the collecting mechanism further comprises an input casing fixed on a rear end wall of the working cavity, wherein the input casing is provided a first round rod fixed to the rear end wall of the working chamber, wherein the first round rod is rotated with a long rod, and the right end of the long rod is fixedly connected with a horizontal block. a lower cavity of the right end wall of the cavity is opened with a short opening facing outward, the horizontal block protrudes out of the outer casing through the short cavity, and a vertical rod is arranged on the left side of the upper end surface of the long pole, and the rear end wall of the working cavity is a vertical slot is provided, wherein the vertical pole can move up and down in the vertical slot, the upper side of the vertical pole is provided with a cover plate, and the left side of the cover plate is provided with a long shaft, the outer casing A curved rod is symmetrically fixed on the left end surface, and the curved rod is rotatably connected to the long shaft.

3. The pulverizing and packaging device for crushing glass according to claim 1, wherein said pulverizing mechanism is described in detail, said pulverizing mechanism further comprising a vertical groove located in a rear end wall of said working chamber a vertical rod is arranged to slide up and down in the vertical groove, a movable plate is arranged on a lower side of the vertical rod, the movable plate is rotatably connected to the second round rod, and the second round rod is fixed behind the working cavity a torsion spring is disposed between the second round rod and the movable plate, the socket is connected to the motor through the electric wire, and the first gear is fixed on the first crushing shaft. a second gear is fixedly disposed on the second crushing shaft, and the first gear meshes with the second gear, and the first gear can drive the second gear to rotate.

4. The pulverizing and packaging device for crushing glass according to claim 1, wherein the packaging mechanism further comprises a packaging frame fixed on the rear end wall of the working cavity, and the lower side of the packaging frame is provided. There is a load frame, a return spring is disposed between the load frame and the short plate, a load carrying cavity is disposed in the load frame, and a telescopic spring is fixed on the right side of the end face of the short plate, and the upper side of the telescopic spring is fixed a transmission rod is disposed, and a third round rod is fixed on the rear end wall of the working chamber, and the transmission rod and the reel are fixedly arranged from the rear to the front on the third round rod, and the transmission gear is The transmission rod is engaged, the packaging frame is provided with a horizontal groove, the lower end wall of the lateral groove is provided with a small groove, and the restriction groove is slidably disposed in the small groove, and the restriction block passes through the thin wire and the reel The connecting block can drive the short rod to move back and forth. The front side of the short rod is fixedly provided with a heating strip, and the upper side of the heating rod is fixedly provided with a small socket, and the small socket can move forward and backward with the short rod. a small electric wire is disposed between the small socket and the heating bar, and the packaging a heating chamber with an opening rearward is opened in the front wall, a small battery is fixed in the heating chamber, and a front groove wall is provided on the front end wall of the packaging frame, and a horizontal axis is arranged in the wide groove. A gear is fixedly disposed on a left end of the horizontal axis, and a small door is fixedly connected to a lower side of the horizontal axis.

5. The pulverizing and packaging device for crushing glass according to claim 1, wherein the closing mechanism comprises a fourth round rod fixed on the rear end wall, and the fourth round rod is fixedly disposed on the fourth round rod. a large gear, a front side of the large gear is provided with a pinion fixedly connected to the fourth round rod, a sliding groove is arranged in a rear end wall of the working cavity, and a wooden block is arranged on the left and right sides of the sliding groove. The left end surface of the wooden block is fixedly provided with a rack, the rack meshes with the pinion gear, and the first vertical plate, the second vertical plate, the third vertical plate and the fourth vertical plate are sequentially arranged on the right side of the wooden block An obliquely downward inclined plate is fixed on the left end surface of the fourth riser.

6. The pulverizing and packaging device for crushing glass according to claim 1, wherein the slider is kept stationary when not subjected to an external force, and does not move when moving downward. The vertical rod contacts, and when the vertical rod moves upward, the slider can be reset.

7. The pulverizing and packaging device for crushing glass according to claim 1, wherein the thin wire protrudes to the right, and when the baffle is rotated upward, the baffle is still slightly inclined downward to the right.

8. The pulverizing and packaging device for crushing glass according to claim 1, wherein the upper side of the garbage bag is placed on the upper side of the packing frame.
